(19) United States
(12) Patent Application Publication
(10) Pub. No.: US 2008/0183733 A1
(43) Pub. Date: Jul. 31, 2008

(54) METHOD, SYSTEM, AND PROGRAM PRODUCT FOR THE CREATION AND USE OF A UNIFIED DYNAMIC INFORMATION SYSTEM

(75) Inventor: James E. Jackson, Wamboin (AU)

Correspondence Address: HOFFMAN WARNICK LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 11/668,564

(22) Filed: Jan. 30, 2007

(51) Int. Cl. G06F 17/30

(52) U.S. Cl. 707/101; 707/E17.009

(57) ABSTRACT

The invention provides a method, system, and program product for creating and/or using unified dynamic information systems that integrate human process data and, optionally, technology component data.

### CROSS-REFERENCE TO RELATED INVENTIONS

This invention is related to U.S. patent application Ser. No. ______ (Attorney Docket No. AU920050004US1) entitled “DYNAMIC INFORMATION SYSTEMS”, and U.S. patent application Ser. No. ______ (Attorney Docket No. AU920060002US1) entitled “METHOD, SYSTEM, AND PROGRAM PRODUCT FOR DISCOVERING RELEVANT INFORMATION IN A DYNAMIC INFORMATION SYSTEM”, both filed on even date herewith, assigned to the same assignee, and hereby incorporated herein by reference in their entirety.

### FIELD OF THE INVENTION

The invention relates generally to dynamic information systems, and more particularly, to unified dynamic information systems that integrate human process data and, optionally, technology component data.

### BACKGROUND OF THE INVENTION

A dynamic information system (DIS) is an information system that embeds its own metadata, exposes that metadata through a metasystem to people with an ongoing responsibility for operation and management of the system, and provides a mechanism for maintaining consistency of the metadata with the system it describes.

An enterprise, including, but not limited to, a corporate enterprise, a government department or agency, a joint venture, or an educational, research, humanitarian, or other agency or institution, is a form of system. By this it is meant that an enterprise is designed, from some abstract conceptual base, to integrate a plurality of components so as to achieve a plurality of purposes. The components of the system that constitutes an enterprise include, but are not limited to, people, organizational structures, machines, knowledge, resources, facilities, locations, utility services, and customers, and the relationships that exist between them. Knowledge also includes information and data components and the machines or tools necessary to manage them.

An enterprise is normally conceived to exist for an unbounded period of time. However, some large projects, which are conceived to exist for a bounded but extended period of time, also have many of the attributes of an enterprise, and may be considered in a similar way. Examples of large projects include, for example, projects for the construction or maintenance of new aircraft types, dams, cities, or large computer systems. Here, the term ‘enterprise’ is taken to include large projects.

During the period of time that the enterprise exists, the system that constitutes the enterprise will be subject to constant change, including, but not limited to, change engendered by changes in the environment and changes initiated within the enterprise itself, such as through a process of constant improvement.

Like any system, systems that constitute enterprises are comprised of two logical subsystems, namely, the deployed system of the enterprise that performs the tasks and activities directly supporting attainment of the purpose of the enterprise and the metasystem of the enterprise that supports the management of the enterprise, including, but not limited to, its definition, design, implementation, governance, monitoring, maintenance, change, and integration.

In current practice, systems that constitute enterprises are not dynamic systems, because their metasystems are not dynamic. Further, the systems that constitute enterprises are rarely designed and built from the base of a comprehensive, consistent, and explicit abstract model. Instead, they are designed and built from a base of examples, received knowledge, and “best practice.” Because abstract models are not employed, the designers, constructors, and maintainers of the systems that constitute enterprises have no valid theoretical base for design, construction, maintenance, or operation of the system that constitutes the enterprise.

The outcome of this is that the systems that constitute an enterprise are subject to much unnecessary effort in matters such as organizational structure and policies, to wastage of resources or failure to effectively employ resources because of endemic nugatory activity or fundamental gaps in process, and to ineffective planning and coordination due to ineffective response to change and/or an incapability to anticipate change. Many enterprises fail to meet their potential performance on relation to their purpose or fail completely as a result.

A valid abstract model exists in the science of cybernetics, first described by Norbert Wiener (Cybernetics, or Control and Communication in the Animal and Machine, 1948), and subsequently extended by Stafford Beer specifically in the context of enterprises—the Viable System Model (VSM) (Platform for Change, Designing Freedom, Heart of Enterprise, and The Brain Of The Firm). An illustrative diagram of the VSM is shown in FIG. 1, depicting the interaction of Environment, Metasystem, and Operation components in the system. FIG. 1 also shows the recursive nature of the VSM, wherein each Operation component includes a VSM, the Operation component of which includes a VSM, etc.

Other abstract models exist. For example, FIG. 2 shows a flow diagram of Walter Shewhart's “plan-do-check-act (PDCA)” cycle, also known as the Deming Cycle, described in Shewhart's Statistical Method from the Viewpoint of Quality Control. The difficulty with cybernetics and the VSM is precisely that they are described in abstract and sometimes mathematical terms, and therefore their practical application is not easily comprehended.

Accordingly, there exists a need in the art to overcome the deficiencies and limitations described hereinabove.

### SUMMARY OF THE INVENTION

The invention provides a method, system, and program product for creating and/or using unified dynamic information systems that integrate human process data and, optionally, technology component data.

A first aspect of the invention provides a method for integrating human process data and technology component data in a unified dynamic information system (UDIS), the method comprising: embedding in a dynamic information system (DIS) containing technology component metadata a unifying metasystem; linking human process metadata with the technology component metadata in the unifying metasystem; and employing the metasystem to carry out a task related to the UDIS.

A second aspect of the invention provides a dynamic information system (DIS) tool comprising: a model derived from a viable system model (VSM) having an interface that supports at least one of the following: a design of a metasystem for a system that constitutes an enterprise; and management of a metasystem for a system that constitutes an enterprise; and at least one rule derived from the VSM that supports analysis of the design or a functioning of the metasystem that supports the system that constitutes the enterprise, wherein the model and the at least one rule are used to provide feedback to a designer as to the completeness and validity of the design or a manager as to the functioning of the enterprise.

A third aspect of the invention provides a system for integrating human process data and technology component data in a unified dynamic information system (UDIS), the system comprising: a system for embedding in a dynamic information system (DIS) containing technology component metadata a unifying metasystem; a system for linking human process metadata with the technology component metadata in the unifying metasystem; and a system for employing the metasystem to carry out a task related to the UDIS.

A fourth aspect of the invention provides a program product stored on a computer-readable medium, which when executed, integrates human process data and technology component data in a unified dynamic information system (UDIS), the program product comprising: program code for embedding in a dynamic information system (DIS) containing technology component metadata a unifying metasystem; program code for linking human process metadata with the technology component metadata in the unifying metasystem; and program code for employing the metasystem to carry out a task related to the UDIS.

A fifth aspect of the invention provides a method for deploying an application for integrating human process data and technology component data in a unified dynamic information system (UDIS), comprising: providing a computer infrastructure being operable to: embed in a dynamic information system (DIS) containing technology component metadata a unifying metasystem; link human process metadata with the technology component metadata in the unifying metasystem; and employ the metasystem to carry out a task related to the UDIS.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a diagram of the Viable System Model (VSM).

FIG. 2 shows a diagram of the Shewhart Cycle.

FIG. 3 shows a diagram of various models of an enterprise, including the place of a unified dynamic information system (UDIS) according to the invention.

FIGS. 4A-C show block diagrams of illustrative topologies in which a UDIS according to the invention may be employed.

FIG. 5 shows a flow diagram of an illustrative method according to the invention.

FIG. 6 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method, system, and program product for the creation and/or use of a unified dynamic information system (UDIS).

A UDIS extends the Dynamic Information System (DIS) to provide a practical way to employ the Viable System Model (VSM) in the design, construction, and maintenance of the system that constitutes an enterprise. Further, by building upon the capabilities of the DIS as a deployed system, it provides a practical way to operate the system that constitutes the enterprise.

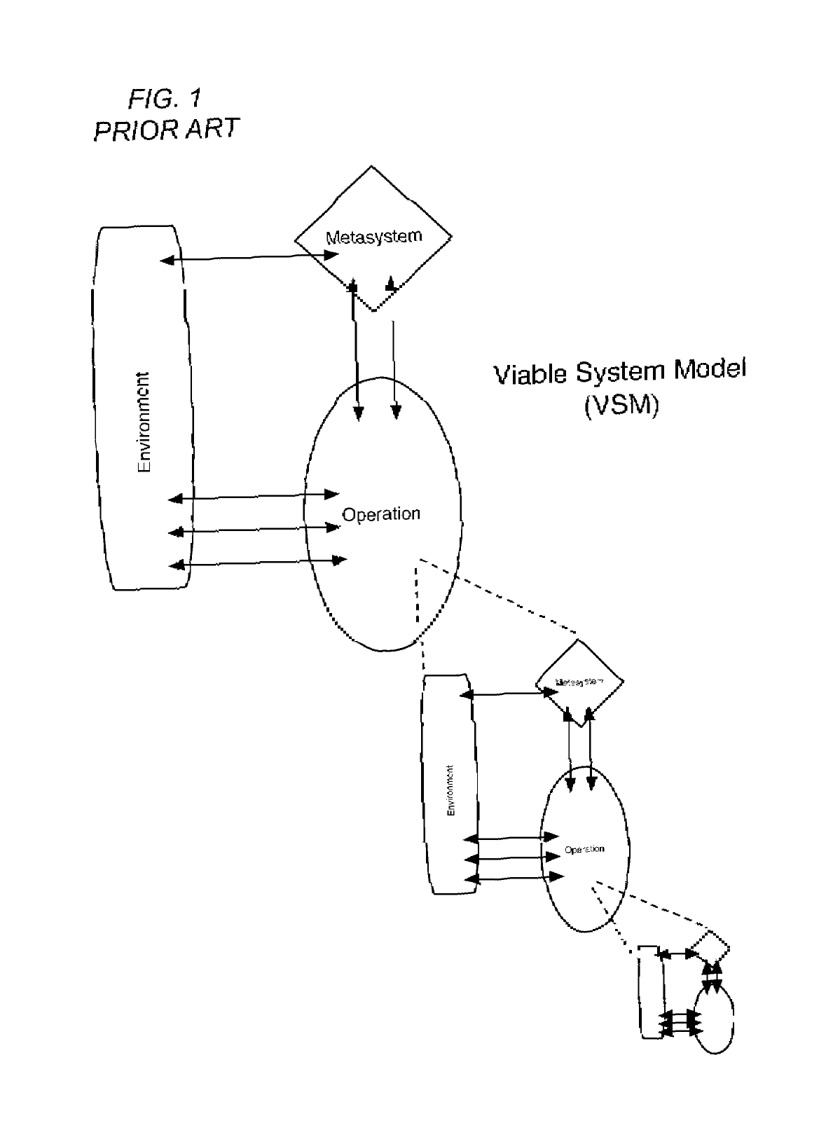

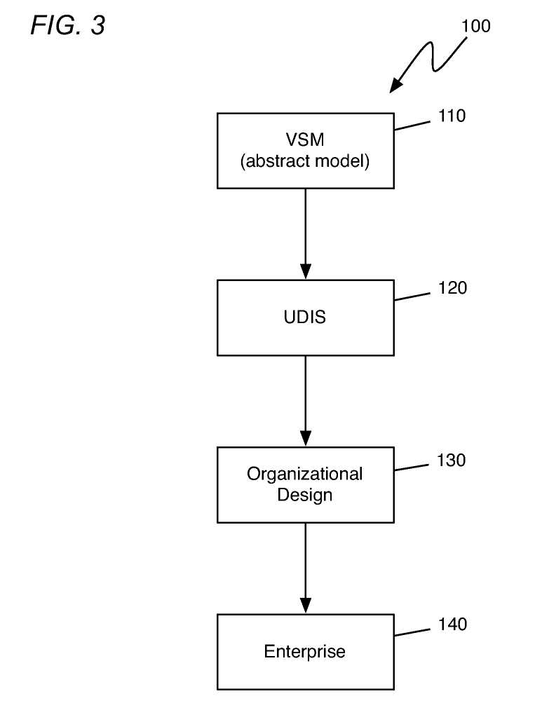

FIG. 3 shows a flow diagram 100 of the place of a UDIS in the context of increasingly-concrete descriptions or models of an enterprise 140. VSM 110 may be viewed as the abstract model upon which the enterprise 140 is based. Generally, the abstract model provided by VSM is a generic model applicable to any enterprise. Thus, VSM 110 may be as simple as that shown in FIG. 1. Alternatively, VSM 110 may provide additional information specific to a particular type of enterprise. For example, where the enterprise is a manufacturing enterprise, the Operation component (see FIG. 1) may include units such as “Fabrication” and “Assembly.” Similarly, the Metasystem component may include units such as “Materials Acquisition” and “Shipping.”

UDIS 120 provides a model of enterprise 140 intermediate those of VSM 110 and Organizational Design 130. For example, UDIS 120 may define the human interactions needed between the Operation and Metasystem components of the VSM 110. To continue with the example given above, UDIS 120 may specify that a member of the “Fabrication” unit notify the “Materials Acquisition” unit of an impending need for a particular raw material or that a member of the “Assembly” unit arrange for shipment of an assembled product by notifying the “Shipping” unit of its completed assembly.

The above examples are provided for purpose of illustration only. The scope of interactions amenable to modeling using UDIS 120 is virtually limitless. A central aspect of UDIS 120, however, is its definition of human actions and interactions in the model. Often, this will require an integration of human actions or interactions with technology components (e.g., a member of “Fabrication” update or query a database of current inventory to determine the need for the raw material), but this is not essential. In some enterprises, most or all of the interactions between VSM components may be exclusive of technology components.

Organizational Design 130 provides a more concrete model of enterprise 130 than either UDIS 120 or VSM 110. Here, the human interactions and interactions defined in UDIS 120 may be further augmented with particular Operation units specific to a particular type of manufacturing enterprise (e.g., a pharmaceutical manufacturer). Finally, enterprise 140 provides the most concrete model, that of the particular enterprise itself (i.e., the particular pharmaceutical manufacturer), with all of its unique features.

Thus, UDIS 120 fulfills a critical void in enterprise modeling, wherein the human actions and interactions underlying the Organizational Design 130 are typically ill-defined or undefined. In addition, where the enterprise is modeled on the VSM, UDIS 120 provides a critical link between the abstract model of the VSM and the more concrete model of the Organizational Design 130. This ensures that such human actions and interactions are available for consideration by the architects, managers, and/or users of a particular enterprise.

A UDIS according to the invention may be employed in any number of ways. For example, the invention provides a model derived from the viable system model (VSM) having an interface that supports at least one of the following: the design of a metasystem for a system that constitutes an enterprise; and the management of a metasystem for a system that constitutes an enterprise; and at least one rule derived from the VSM that supports analysis of the design or the functioning of the metasystem that supports the system that constitutes the enterprise, wherein the model and the at least one rule are used to provide feedback to a designer as to the completeness and validity of the design or a manager as to the functioning of the enterprise.

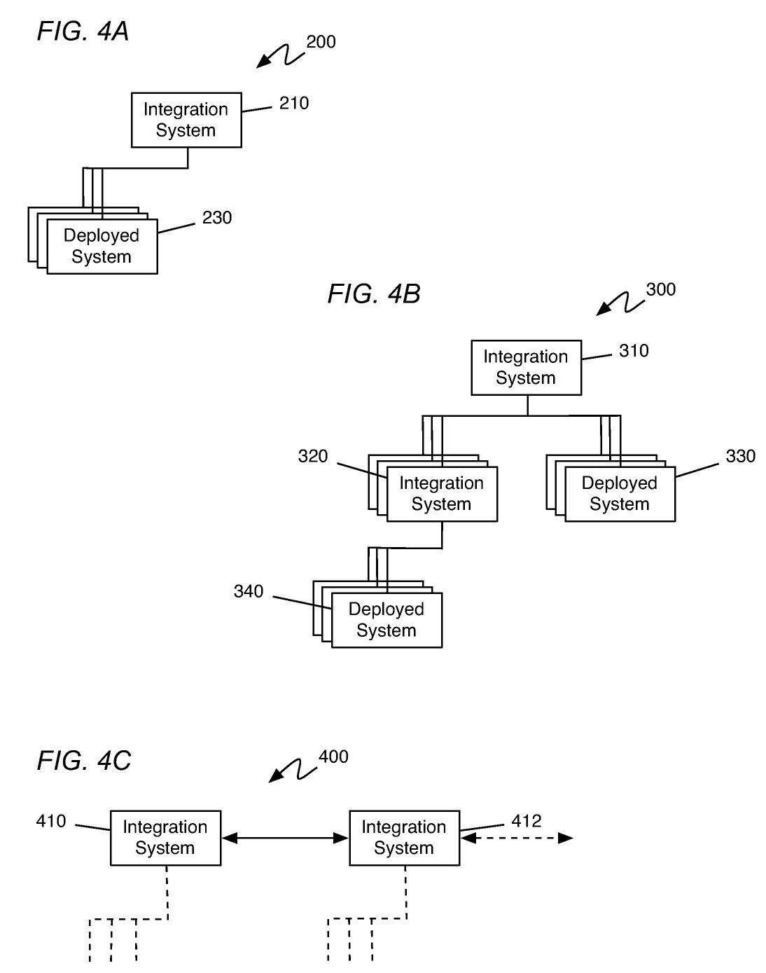

FIGS. 4A-C show various topologies in which a UDIS according to the invention may be employed. FIG. 4A shows a simple hierarchical topology 200 comprising an integration system 210 and a deployed system 230. Other topologies are possible, of course, such as the multi-hierarchical topology model 300 shown in FIG. 4B, with multiple levels of integration systems 310, 320 and deployed systems 330, 340 depending from single- or multiple-levels of integration systems, respectively. Another topology includes the parallel hierarchical topology 400 shown in FIG. 4C, having multiple, parallel integration systems 410, 412.

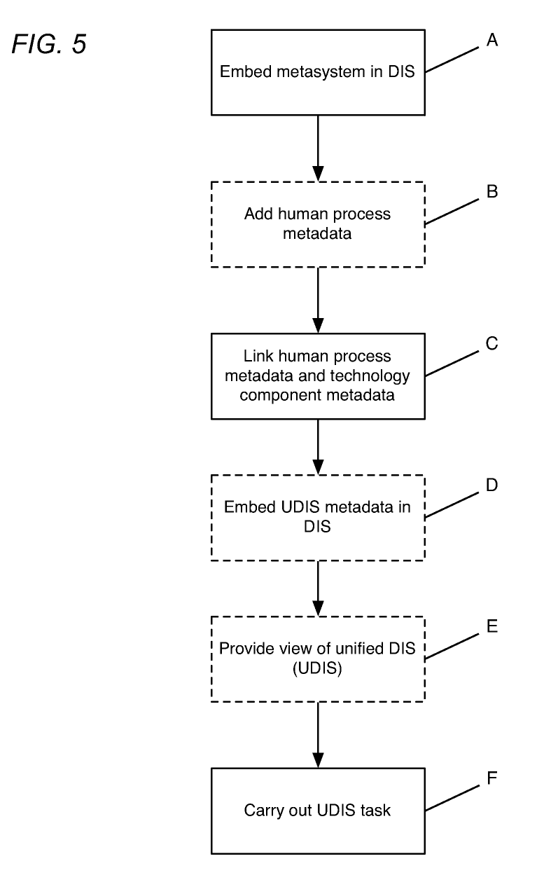

FIG. 5 shows a flow diagram of an illustrative method according to the invention, wherein metadata related to human actions or interactions is integrated with metadata related to technology components.

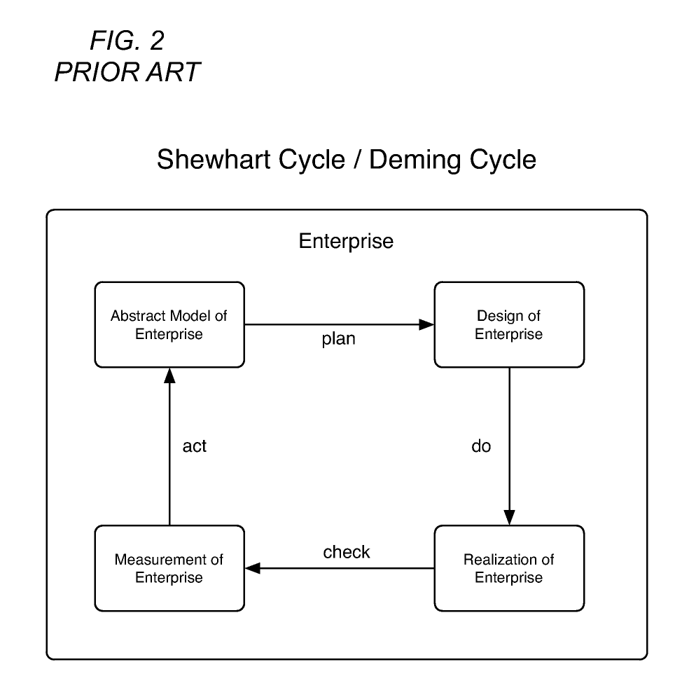

At A, a metasystem is embedded in a dynamic information system (DIS) containing metadata related to technology components (e.g., computers, computer-based systems, etc.). In one embodiment, the metasystem is based on the VSM (see FIG. 1) and/or the PDCA cycle (see FIG. 2).

At B, metadata related to a human process (e.g., data related to the use, operation, maintenance, and/or management of the system) may optionally be added to the DIS. Alternatively, such human process metadata may be included in the metasystem embedded at A.

At C, the human process metadata and technology component metadata are linked in the DIS. For example, using the example provided above, metadata related to the determination of a need for a raw material would then be linked to metadata related to the database containing an inventory of the raw material, the linked metadata being available to system designers, managers, users, etc. A system designer may, therefore, choose to require a member of the “Fabrication” unit to make periodic determinations of need for the raw material. Alternatively, the system designer may choose to provide a mechanism for notifying a member of the “Fabrication” unit of the current inventory and/or the projected consumption of the raw material. Thus, the “Fabrication” unit is less likely to be surprised by unforeseen shortages or surpluses of the raw material. Surpluses may be disadvantageous, for example, where the raw material is subject to spoiling or where large quantities of the raw material are dangerous or expensive to store.

At D, metadata related to the UDIS itself may optionally be embedded in the DIS, thus facilitating a recursive view of the enterprise in the context of a larger enterprise, as shown in FIG. 1.

At E, a view of the UDIS may optionally be provided to a user, manager, or other individual having a need to access the UDIS, as an aid in his/her carrying out a task related to the UDIS at F (e.g., determining how many employees to assign to the “Materials Acquisition” or “Shipping” units). The view at E may take any number of forms. For example, the view may be tailored based on the individual's role (e.g., a user would not be provided a view including managerial tasks). Alternatively, the view may include a temporal component, such that only current or upcoming data are included. This may be advantageous, for example, for those involved in the management and/or maintenance of the system or enterprise.

The task carried out at F may include any task associated with the system or enterprise. Such tasks include, but are not limited to, building, designing, implementing, operating, managing, maintaining, accessing, and using the system.

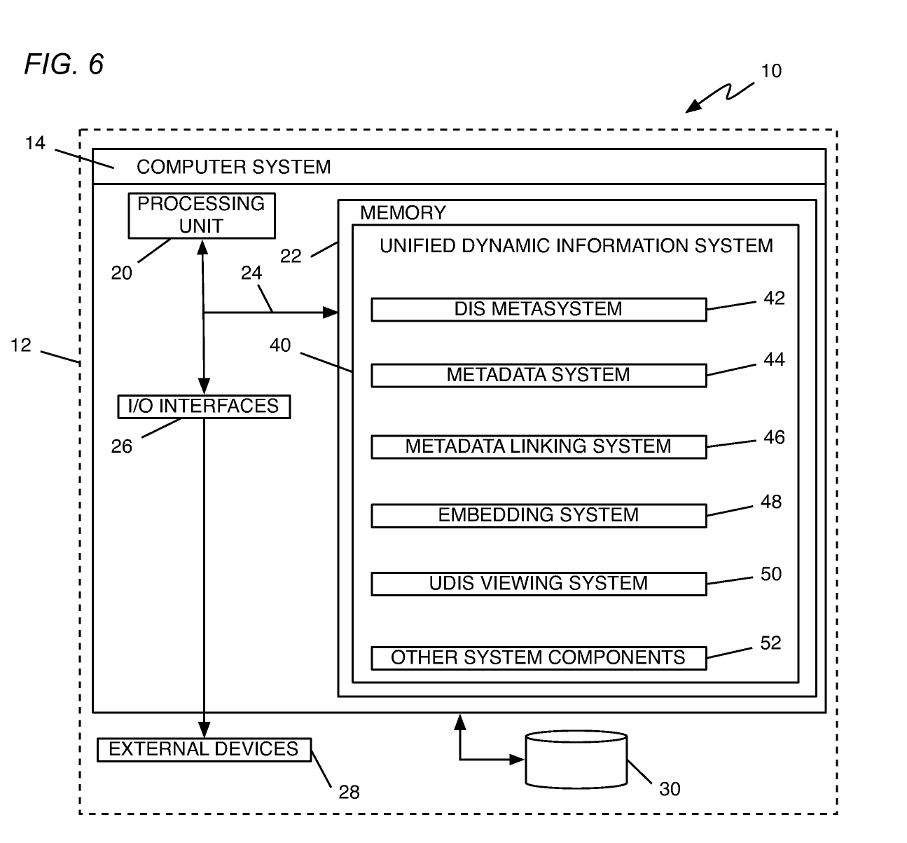

FIG. 6 shows an illustrative system 10 for creating and using a unified dynamic information system (UDIS). To this extent, system 10 includes a computer infrastructure 12 that can perform the various process steps described herein for creating and using a UDIS. In particular, computer infrastructure 12 is shown including a computer system 14 that comprises a UDIS system 40, which enables computer system 14 to create and use a UDIS by performing the process steps of the invention.

Computer system 14 is shown including a processing unit 20, a memory 22, an input/output (I/O) interface 26, and a bus 24. Further, computer system 14 is shown in communication with external devices 28 and a storage system 30. As is known in the art, in general, processing unit 20 executes computer program code, such as UDIS system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and UDIS system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, UDIS system 40 enables computer system 14 to create and use a UDIS. To this extent, UDIS system 40 is shown including a DIS metasystem 42, a metadata system 44, a metadata linking system 46, an embedding system 48, and a UDIS viewing system 50. Operation of each of these systems is discussed above. UDIS system 40 may further include other system components 52 to provide additional or improved functionality to UDIS system 40. It is understood that some of the various systems shown in FIG. 6 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for creating and using a UDIS, it is understood that the invention further provides various alternative embodiments. For example, in one embodiment, the invention provides a computer-readable medium that includes computer program code to enable a computer infrastructure to create and use a UDIS. To this extent, the computer-readable medium includes program code, such as UDIS system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to create a UDIS as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for creating and/or using a UDIS. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for integrating human process data and technology component data in a unified dynamic information system (UDIS), the method comprising:
embedding in a dynamic information system (DIS) containing technology component metadata a unifying metasystem;
linking human process metadata with the technology component metadata in the unifying metasystem; and
employing the metasystem to carry out a task related to the UDIS.

2. The method of claim 1, further comprising:
embedding UDIS metadata in the DIS.

3. The method of claim 1, further comprising:
adding human process metadata to the DIS.

4. The method of claim 1, wherein employing includes at least one of the following: building the UDIS, designing the UDIS, implementing the UDIS, operating the UDIS, managing the UDIS, maintaining the UDIS, accessing the UDIS, and using the UDIS.

5. The method of claim 1, further comprising:
providing a view of the UDIS based on the task to be carried out.

6. The method of claim 1, wherein the metasystem includes a viable system model (VSM).

7. A dynamic information system (DIS) tool comprising:
a model derived from a viable system model (VSM) having an interface that supports at least one of the following:
a design of a metasystem for a system that constitutes an enterprise; and
management of a metasystem for a system that constitutes an enterprise; and
at least one rule derived from the VSM that supports analysis of the design or a functioning of the metasystem that supports the system that constitutes the enterprise,
wherein the model and the at least one rule are used to provide feedback to a designer as to the completeness and validity of the design or a manager as to the functioning of the enterprise.

8. A system for integrating human process data and technology component data in a unified dynamic information system (UDIS), the system comprising:
a system for embedding in a dynamic information system (DIS) containing technology component metadata a unifying metasystem;
a system for linking human process metadata with the technology component metadata in the unifying metasystem; and
a system for employing the metasystem to carry out a task related to the UDIS.

9. The system of claim 8, further comprising:
a system for embedding UDIS metadata in the DIS.

10. The system of claim 8, further comprising:
a system for adding human process metadata to the DIS.

11. The system of claim 8, wherein employing includes at least one of the following: building the UDIS, designing the UDIS, implementing the UDIS, operating the UDIS, managing the UDIS, maintaining the UDIS, accessing the UDIS, and using the UDIS.

12. The system of claim 8, further comprising:
a system for providing a view of the UDIS based on the task to be carried out.

13. The system of claim 8, wherein the metasystem includes a viable system model (VSM).

14. A program product stored on a computer-readable medium, which when executed, integrates human process data and technology component data in a unified dynamic information system (UDIS), the program product comprising:
program code for embedding in a dynamic information system (DIS) containing technology component metadata a unifying metasystem;
program code for linking human process metadata with the technology component metadata in the unifying metasystem; and
program code for employing the metasystem to carry out a task related to the UDIS.

15. The program product of claim 14, further comprising:
program code for embedding UDIS metadata in the DIS.

16. The program product of claim 14, further comprising:
program code for adding human process metadata to the DIS.

17. The program product of claim 14, wherein employing includes at least one of the following: building the UDIS, designing the UDIS, implementing the UDIS, operating the UDIS, managing the UDIS, maintaining the UDIS, accessing the UDIS, and using the UDIS.

18. The program product of claim 14, further comprising:
program code for providing a view of the UDIS based on the task to be carried out.

19. The program product of claim 14, wherein the metasystem includes a viable system model (VSM).

20. A method for deploying an application for integrating human process data and technology component data in a unified dynamic information system (UDIS), comprising:
providing a computer infrastructure being operable to:
embed in a dynamic information system (DIS) containing technology component metadata a unifying metasystem;
link human process metadata with the technology component metadata in the unifying metasystem; and
employ the metasystem to carry out a task related to the UDIS.

21. The method of claim 20, the infrastructure being further operable to:
embed UDIS metadata in the DIS.

22. The method of claim 20, the infrastructure being further operable to:
add human process metadata to the DIS.

23. The method of claim 20, wherein employing includes at least one of the following: building the UDIS, designing the UDIS, implementing the UDIS, operating the UDIS, managing the UDIS, maintaining the UDIS, accessing the UDIS, and using the UDIS.

24. The method of claim 20, the infrastructure being further operable to:
provide a view of the UDIS based on the task to be carried out.

25. The method of claim 20, wherein the metasystem includes a viable system model (VSM).
